(19) United States
(12) Patent Application Publication
(10) Pub. No.: US 2014/0319320 A1
(43) Pub. Date: Oct. 30, 2014

(54) OCCUPANCY SENSOR DEVICE

(71) Applicant: Varun Akur Venkatesan, Bangalore (IN)

(72) Inventor: Varun Akur Venkatesan, Bangalore (IN)

(73) Assignee: OSRAM GMBH, Muenchen (DE)

(21) Appl. No.: 14/343,399

(22) PCT Filed: Aug. 24, 2012
(86) PCT No.: PCT/EP2012/066543

§ 371 Date: Jun. 17, 2014

(30) Foreign Application Priority Data
Sep. 9, 2011 (IN) 1182/KOL/2011

(51) Int. Cl. G01V 8/20

(52) U.S. Cl. CPC G01V 8/20
USPC 250/206.1

(57) ABSTRACT

The invention relates to an integrated light and occupancy sensor device having an overall angular field of view, including an array of modified LED elements; a segmented filtering aperture means having a slit aperture defined by a slit length and a slit width that is significantly smaller than the array length, the slit aperture means being positioned at a distance away from the linear array and so oriented that the slit length crosses the array in a transverse direction; and a processor being operably connected to said array to process light data values corresponding to the light signals, the processor operable in first and second modes.

### RELATED APPLICATIONS

The present application is a national stage entry according to 35 U.S.C. §371 of PCT application No.: PCT/EP2012/066543 filed on Aug. 24, 2012, which claims priority from Indian application No.: 1182/KOL/2011 filed on Sep. 9, 2011, and is incorporated herein by reference in its entirety.

### TECHNICAL FIELD

Various embodiments relate to ambient light and robust motion detection sensors and, more particularly, to an integrated robust occupancy sensors with the use of an array of light emitting diodes which double as photo receivers having improved ambient light sensing and occupancy sensing capabilities.

### BACKGROUND

Occupancy sensors have been manufactured using either ultrasonic devices or passive infrared receivers. These sensors are not very robust and need to be tweaked. Ultrasonic sensors consume energy and passive infrared sensors can be confused by several external agents.

Cameras can also be used to detect human/vehicle presence, but they have the following problems.
a) Lesser light detection capabilities hence need external lighting thereby consuming power. IR cameras that do not need external lighting are very expensive.
b) lower field of view
c) No flexibility in form factor.

Architectural lighting systems may be controlled by electronic systems that activate the luminaires into an on or off condition depending on the presence of occupants in the room and by systems that adjust the luminaire light levels depending on the amount of present ambient light, which may include both natural and artificial light.

Systems that activate the luminaires into the on or off condition depending on the presence of occupants in the room typically require an occupancy sensor to detect the presence of a person or persons within the room. The two most commonly used types of occupancy sensors are passive infrared detectors and ultrasonic transceivers.

Passive infrared detectors are sensitive to warm objects such as human bodies that radiate most of their thermal energy in the far region of the infrared spectrum between 6 to 10 microns. The detector is sensitive to sudden changes in the amount of the far infrared light it receives and produces a small electrical voltage as its temperature changes by a few thousandths of a degree. Once thermal equilibrium is reached the detector no longer produces any electrical signal. By using an array of lenses, the sensitivity of the detector is divided into several zones. A person moving across the field of view of the detector will cross one or more of these zones, so that the change in amount of received thermal energy as the person moves from zone to zone will produce a changing electrical voltage that can be detected.

One disadvantage of this type of sensor is that a person must be moving in order to be reliably detected. If an occupant sits or stands relatively motionless for a few minutes, a passive infrared occupancy sensor is unable to detect the presence of the occupant and may turn the luminaires off if there is nobody else in the room. Another disadvantage of this type of sensor is that the plastic Fresnel lens arrays typically used are relatively large, typically at least 15 mm in diameter. This is so because the only common plastic material that is transparent in the far infrared region is polyethylene. Polyethylene is a relatively soft plastic, which makes it difficult to mold small-scale features onto its surface. Yet another disadvantage of this type of sensor is that images formed by the array of lenses overlap and thereby reduce the contrast of individual images. Consequently, the separation of the sensor field of view into zones is not complete.

Other disadvantages of such a sensor include the fact that it is very sensitive to thermal drafts and other sudden changes in ambient air temperature, acoustic disturbances, and radio frequency interference. Thus, false triggering of the luminaires may occur by placing the sensor too close to an air vent in a room, by mechanical vibrations and loud sounds, or by transient RFI signals produced by power electronics used in architectural lighting systems controls. Furthermore, passive infrared detectors have an effective range of approximately twenty feet (six meters) when used in architectural occupancy sensors. This is so because, for distances greater than twenty feet, the amount of thermal energy radiated by a human body is insufficient to be reliably detected against the background thermal radiation from other surfaces in the room.

The other most common type of occupancy sensor is an ultrasonic transceiver. Ultrasonic transceivers consist of an ultrasonic transmitter that emits bursts of high-frequency sound, and an ultrasonic receiver that listens for the echoes from nearby surfaces. If a person or other object moves between these bursts, the intensity and duration of the echoes will change.

A disadvantage of ultrasonic transceivers is that multiple ultrasonic transceivers within a room can interfere with each other's operation. This is so because there is no easy means of distinguishing the echoes from a transmitted ultrasonic burst from those bursts emitted by other units. Ultrasonic detectors may also inadvertently detect movement outside of their intended field of view within a room because of ultrasonic echoes from multiple reflections within a room and adjoining spaces, such as hallways. Another problem with ultrasonic detectors is that large and bulky receiver horns are necessary to limit the field of view to specific angles.

Given these limitations, some occupancy sensor manufacturers have recently

resorted to using complex and relatively expensive digital signal processors that are programmed to analyze the received train of ultrasonic echoes and filter out background noise. They and other manufacturers also offer combination occupancy sensors that include both passive infrared detectors and ultrasonic transceivers. These devices produce an output, typically a low voltage signal or an electromechanical relay closure, only if both sensors detect movement within their respective fields of view.

Systems that adjust the luminaire light levels depending on the amount of present ambient light require alight sensor to monitor the ambient light present in the room. There are two types of commonly used ambient light sensors.

One type of ambient light sensor is a light-dependent resistor. This type of sensor is constructed from a thin film of cadmium sulfide or similar material whose electrical resistance varies in relation to the amount of light incident on it. The spectral sensitivity of a light-dependent resistor closely matches that of the human visual system. Light-dependent resistors are most often used as daylight sensors in outdoor motion detectors to ensure that security luminaires are not activated during daylight hours.

Another type of ambient light sensor is a silicon photodiode. Silicon photodiodes are silicon-based semiconductors that produce a small electric current when exposed to light. By themselves, silicon photodiodes are more sensitive to near infrared light (0.9 micron) than they are to visible light (0.4 to 0.7 micron). However, suitable glass or plastic filters can be used to filter the incident light and produce sensors whose spectral sensitivity more closely matches that of the human visual system. These filters are typically mounted directly on the sensor housing by the sensor manufacturer.

A disadvantage of both light-dependent resistors and silicon photodiode sensors is that they produce analog output signals, whereas most sophisticated monitoring and control systems for architectural lighting are based on digital computer control. In these cases, an analog-to-digital converter is required to convert the analog output signals from the ambient light sensors into equivalent digital signals.

Video surveillance cameras may also be used for sophisticated occupancy detection applications. Individual video frames can be captured by a computer and quickly analyzed for changes from previously captured images. However, these cameras require a considerable quantity of electronics hardware to produce digital images from the analog video signal. A considerable amount of computer processing power and memory is needed to analyze the captured video frames.

While most video sensors are designed as rectangular arrays of photodiode light sensors, some applications require linear arrays. Examples include industrial machine vision systems, bar code scanners, document scanners, and optical character recognition systems. The primary disadvantage of linear photodiode arrays is that they provide an image consisting of a single line when used with one or more spherical lenses. This is appropriate for their intended applications, where objects are mechanically scanned past the field of view of the sensor. It is not appropriate for occupancy sensors, however, where a wide-angle field of view in two dimensions is typically required.

Various systems incorporating one or more infrared and/or acoustical ranging sensors have been proposed for this purpose; see, for example, the U.S. Pat. Nos. 5,330,226 and 5,785,347. In general, such systems emit one or more beams of infrared energy to define a corresponding number of viewing fields, and receive the reflected energy to detect the presence of an occupant within the viewing fields. However, the information obtained by such techniques is sometimes corrupted by other light sources (such as reflected sunlight, or pulsed incandescent light), and even under best conditions is typically insufficient to accurately classify the occupant type and position.

In another prior art a European specification EP1033290 from DELPHI TECHNOLOGIES discloses an improved IR occupant position detection system that provides accurate and reliable classification and position information at a speed sufficient to timely inhibit or otherwise control deployment of occupant restraints. A two-dimensional array of IR emitters is selectively activated to periodically illuminate two or more predetermined viewing planes in the vicinity of a passenger seating area, and the reflected IR energy is detected by a photo-sensitive receiver and analyzed to detect the presence of an occupant, to classify the occupant, and to identify and dynamically track the position of the occupant's head/torso relative to predefined zones of the passenger compartment. Modulating the intensity of the emitted IR beams with a known carrier frequency, band-pass filtering the received signal, and synchronously detecting the filtered signal distinguishes the reflected IR energy from other signals picked up by the IR receiver.

### SUMMARY

Various embodiments provide an integral ambient light and occupancy sensor that is based on a modified LED by introducing a photosensitive material at the periphery and capable of concurrent ambient light and object motion detection.

Various embodiments further provide a modified LED, wherein the photosensitive material is active in the spectrum outside the emission spectrum of LED.

Various embodiments still further provide such a sensor that is cheaper and more energy savings from larger aperture size than regular camera based systems.

Various embodiments still further provide a sensor capable of having a wide field of view and further have higher robustness that the existing occupancy sensors.

Various embodiments further provide a filtering aperture, which is transparent in the spectrum of the emission of LED but has several areas opaque in the spectrum of the photo receiver.

As per an exemplary embodiment of the present disclosure the occupancy sensor disclosed herein has a flexible construction, i.e. the modified LED's need not be in a single phase.

Further embodiment of the present disclosure provides such a sensor that is insensitive to electrical and acoustic interference from architectural lighting systems.

As per yet another exemplary embodiment of the present disclosure the sensor is capable of sensing the depth estimation (3D Camera), applications for surveillance and traffic monitoring.

The present disclosure is a sensor implemented with a single light sensing device to detect ambient light levels and object motion. The sensor includes an array of modified LED's, positioned downstream of a segmented slit aperture device comprising a single, segmented filtering aperture, the slit length of which is oriented perpendicular to the length of the linear array. The individual said LED's of the array provide motion detection capability in a direction perpendicular to the slit length. The slit aperture is segmented along the slit length to form multiple zones of sensor light responsivity that provide motion detection capability in a direction parallel to the slit length.

Further as an embodiment there is provided a programmed processor for the reconstruction of a higher resolution image of the scene underneath the number of photo receivers in the LED array.

An optional visible light filter positioned upstream of the multiple slit aperture matches the spectral response of the linear array of photodiodes to approximately that of the human visual system.

Accordingly, there is provided An integrated light and occupancy sensor device having an overall angular field of view, comprising an array of modified LED elements; a segmented filtering aperture means having a slit aperture defined by a slit length and a slit width that is significantly smaller than the array length, the slit aperture means positioned at a distance away from the linear array and so oriented that the slit length crosses the array in a transverse direction; and a processor operably connected to said array to process light data values corresponding to the light signals, the processor operable in first and second modes, in the first mode the processor determining from the light data values a quantity representing an average measure of the light incident on the linear array, and in the second mode the processor determining from light data values acquired at different times for corresponding light sensitive elements to detect the existence of an object motion within the overall angular field of view of the sensor.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 illustrates a typical LED, which can be used as an array to light large areas in accordance with the present disclosure;

FIG. 2 illustrates a modified LED with a photosensitive material at the periphery in accordance with the present disclosure;

FIG. 3 illustrates the LED array mounted on a panel and placed over a filtering aperture in accordance with the present disclosure; and

FIG. 4 illustrates the LED array which can be shaped as a bulb and can act as camera as an exemplary embodiment in accordance with the present disclosure.

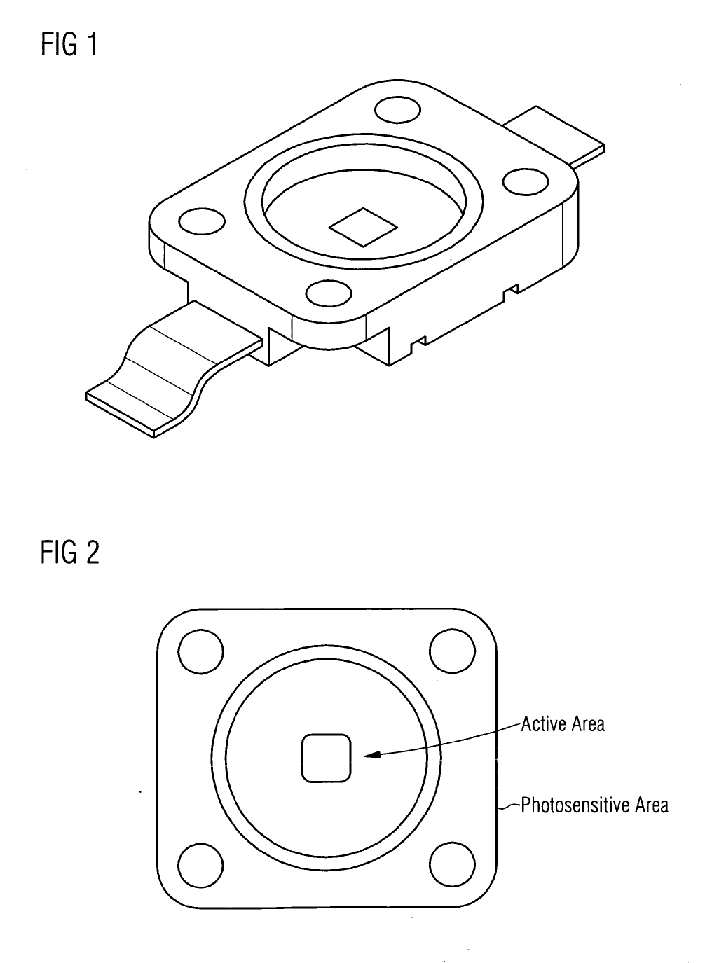

### DETAILED DESCRIPTION

The following detailed description refers to the accompanying drawing that show, by way of illustration, specific details and embodiments in which the disclosure may be practiced.

The disclosure discusses the design of a robust occupancy sensor with the use of an array of LED's which double as photo receivers.

According to the disclosure, prior art LEDₛ (which can be used as an array to light large areas) are modified by introduction of a photo-sensitive material at the periphery, the photo-sensitive material at the periphery, the photo-sensitive material being active in the spectrum outside the emission spectrum of the LED. Since the photo receiver is sensitive outside the spectrum of emission of the LED, it does not respond to the light emitted by the LED, but responds the light from the external. In another embodiment, the photo receiver can be placed adjacent to the LED.

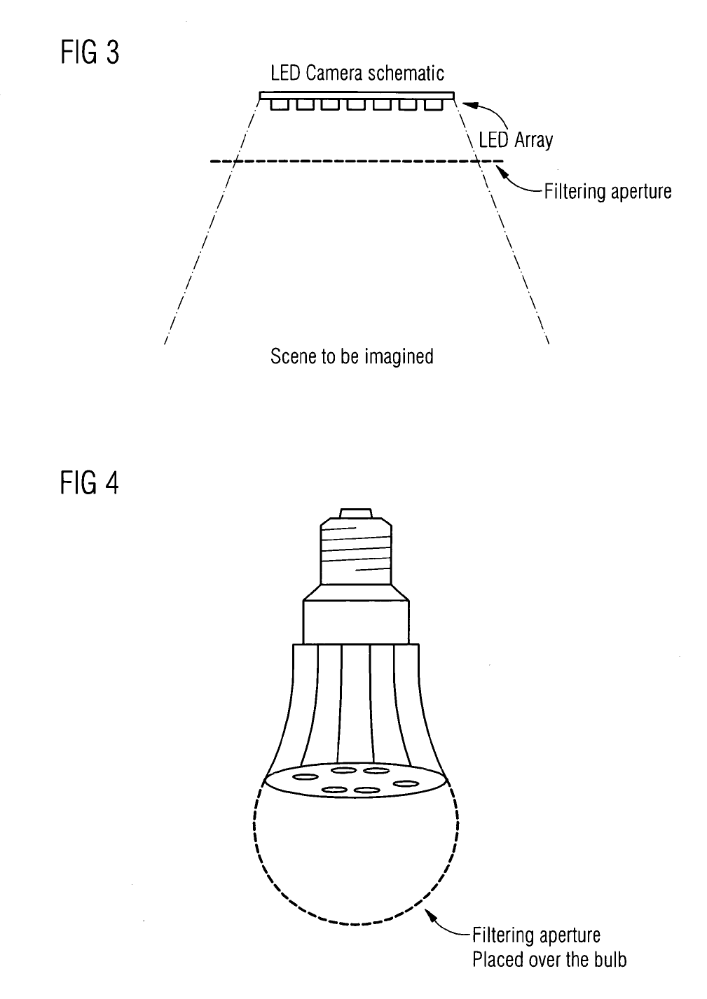

As shown in FIG. 3, an array of such LEDₛ is mounted on a panel in any form desired. This panel is placed above a filtering aperture. The filtering aperture is transparent in the spectrum of emission of the LED but has several areas opaque in the spectrum of the photo receiver. The photo receiver in each LED receives a multiplexed value of the light emitted from the scene and the entire scene can be reconstructed using photo receiver values from several LEDₛ. There exist algorithms that allow for reconstructing a higher resolution image of the scene underneath than the number of photo receivers in the LED array. Also, the LED array need not be shaped in a regular fashion. The panel need not be planar. FIG. 4 shows another embodiments of such a device.

The present disclosure has following advantages:
Cheaper and More Energy savings from larger aperture size than regular camera based systems
Higher robustness than existing occupancy sensors
Wide field of view
Flexible construction, the LEDₛ need not be in a single plane!
Possibility of depth estimation (3D camera), applications for surveillance and traffic monitoring.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An integrated light and occupancy sensor device having an overall angular field of view, comprising:
an array of modified LED elements;
a segmented filtering aperture means having a slit aperture defined by a slit length and a slit width that is significantly smaller than the array length, the slit aperture means being positioned at a distance away from the linear array and so oriented that the slit length crosses the array in a transverse direction; and
a processor operably connected to said array to process light data values corresponding to the light signals, the processor being operable in first and second modes, in the first mode the processor determining from the light data values a quantity representing an average measure of the light incident on the linear array, and in the second mode the processor determining from light data values acquired at different times for corresponding light sensitive elements to detect the existence of an object motion within the overall angular field of view of the sensor.

2. The integrated light and occupancy sensor device as claimed in claim 1 wherein the distance between said array and the slit aperture means contributes to the overall angular field of view of the sensor.

3. The integrated light and occupancy sensor device as claimed in claim I wherein the LED is modified by the introduction of photosensitive material at the periphery.

4. The integrated light and occupancy sensor device as claimed in claim 3 wherein the photosensitive material is active in the spectrum outside the emission spectrum of the LED.

5. The integrated light and occupancy sensor device as claimed in claim 4 wherein the photo receiver is placed adjacent to the LED.

6. The integrated light and occupancy sensor device as claimed in claim 1 wherein the filtering aperture is transparent in the spectrum of emission of LED and has several areas opaque in the spectrum of the photo receiver.

7. The integrated light and occupancy sensor device as claimed in claim 1 wherein the array of LED's is fixed on a panel.

8. The integrated light and occupancy sensor device as claimed in claim 7 wherein the panel is not planar.

9. The integrated light and occupancy sensor device as claimed in claim 1 wherein the LED's are not fixed in a single panel.

10. The integrated light and occupancy sensor device as claimed in claim 1 wherein the processor is programmed for the reconstruction of a higher resolution image of the object underneath the number of photo receivers in the LED array.
